(19) United States
(12) Patent Application Publication
(10) Pub. No.: US 2002/0004747 A1
(43) Pub. Date: Jan. 10, 2002

(54) Method and apparatus for supplying vehicle maintenance and parts information

(76) Inventor: Ken Nishioka, Toyoake-city (JP)

Correspondence Address: LAW OFFICE OF DAVID G POSZ, 2000 L STREET, N.W., SUITE 200, WASHINGTON, DC, 20036, US

(21) Appl. No.: 09/862,516

(22) Filed: May 23, 2001

(30) Foreign Application Priority Data
Jul. 10, 2000 (JP) 2000-208836

(51) Int. Cl. G06F 17/60

(52) U.S. Cl. 705/14

(57) ABSTRACT

A vehicle information supply system comprises user terminals and an information center connected to each other through a communication network. The information center stores maintenance management information of a user's vehicle in its user-divided database, and information regarding maintenance works provided by advertisement requestors in its advertisement requestor-divided database. The information center links the stored maintenance management information and the stored maintenance work information and extracts a maintenance work which is required by the user for the vehicle and corresponds to the required maintenance work. The information center transmits a message to a user terminal of the user to notify the time of next regular vehicle inspection along with information about an advertisement requester which provides the extracted maintenance service.

### CROSS REFERENCE TO RELATED APPLICATION

This application is based on and incorporates herein by reference Japanese Patent Application No. 2000-208836 filed on Jul. 10, 2000.

### BACKGROUND OF THE INVENTION

The present invention relates to a method and apparatus for supplying vehicle information such as maintenance and parts.

Vehicles must be inspected regularly for safety and other reasons. Vehicle dealers inform by direct mails vehicle owners when the vehicles should be inspected, as a maintenance time management. However, the content of this information is limited. Thus each owner has to determine when various condition of the vehicle should be inspected and repaired, and when oil, filters and other parts should be replaced.

Service shops other than the dealers also provide vehicle users with parts information regarding respective vehicles by direct mails and advertisements on newspapers and the like. However, these parts information include parts information other than that of a specific vehicle. Therefore, each owner has to select only a part of information that relates to the specific vehicle.

### SUMMARY OF THE INVENTION

It is therefore an object of the present invention to provide a method and apparatus which is capable of supplying vehicle information such as maintenance management information and parts information specific to each vehicle.

According to the present invention, a vehicle information supply system comprises user terminals and an information center connected to each other through a communication network. The information center stores maintenance management information of vehicles in its user-divided database in response to inputs of vehicle owners, and information regarding maintenance works provided by advertisement requesters in its advertisement requestor-divided database in response to requests from the advertisement requestors. The information center links the stored maintenance management information and the stored maintenance work information and extracts a maintenance work which is required by a user for a vehicle and corresponds to the required maintenance work. The information center transmits a message to a user terminal of the user to notify the time of next regular vehicle inspection along with information about an advertisement requester which provides the extracted maintenance work.

### BRIEF DESCRIPTION OF THE DRAWINGS

The above and other objects, features and advantages of the present invention will become more apparent from the following detailed description made with reference to the accompanying drawings. In the drawings:

FIG. 1 is a diagrammatic view showing an information supply system according to an embodiment of the present invention;

FIG. 2A is a flow diagram showing processing executed by a user terminal, and

FIG. 2B is a flow diagram showing processing executed by an information center; and

FIG. 3 is a diagrammatic view showing a display screen of the user terminal.

### DETAILED DESCRIPTION OF THE PREFERRED EMBODIMENT

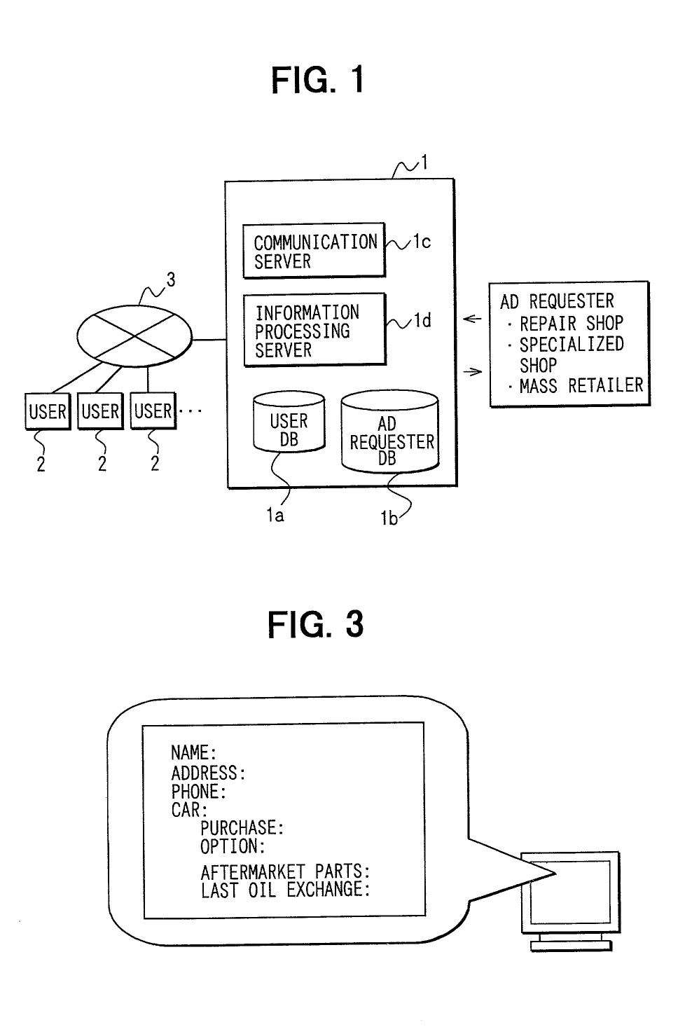

Referring first to FIG. 1, an information supply system has an information center 1, and a plurality of information terminals (clients) that is used as user terminals by respective users, specifically vehicle owners. The information terminals 2 are connected to each other through a communication network 3.

The information center 1 is an apparatus that is used by information providers for providing respective services. It has a user-divided database (first storage unit) 1a for storing private information regarding each user, an advertisement requester-divided database (second storage unit) 1b for storing information of advertisement requesters regarding vehicles, a communication server 1c and an information processing server 1d.

The information center 1 may be comprised of a personal computer, workstation or the like, and has storage medium such as a hard disk that stores a program for executing the information supply as described below. This program is installed in the storage medium of the information center 1 from an external storage medium such as a CD-ROM.

The user terminal 2 is of a type that is capable of transmitting and receiving various information to and from the information center 1 through the communication network 3. The user terminal 2 may be a personal computer at home, a cellular phone carried by a person or a navigation system mounted in a vehicle for a travel guidance.

The communication network 4 may be an open-type network such as INTERNET, a local network (LAN) or a personal computer communication.

In this information supply system, the information stored in the user-divided database 1a and advertisement requestor-divided database 1b are constructed to be updated by the information processing server 1d from time to time.

The user-divided database 1a has user addresses specific to respective users, and the private information of each user is stored in the corresponding user address. The private information includes maintenance management information such as an inspection time and oil exchange time of a vehicle of each user, preference information regarding optional parts such as tires and audio devices used in the vehicle of each user, and the like.

The advertisement requestor-divided database 1b has requester addresses specific to respective advertisement requesters who concluded agreements with the information provider, and the private information of each requester is stored in the corresponding requestor address. The private information includes services provided by each advertiser requester. Such services include repair shops which provide vehicle inspection work, specialized shops which sell vehicle parts, mass retailers which not only sell vehicle parts but also provide oil exchange work, and the like. These information are stored by classifying types of advertisement requesters.

The information of the repair shop specifies what maintenance work (vehicle inspection, body fixing repair, and the like). The information of the specialized shop specifies types and prices of optional parts, and the like. The information of the mass retailer specifies both of the maintenance work and the parts.

Upon an access request from a user or an advertisement requester, the server 1c checks such an access requestor based on the identification code (ID) of the user or the advertisement requestor. The server 1c connects the information center 1 and the corresponding user terminal 2 after completing the recognition of such an access requester.

The information processing server 1d transmits to the corresponding user terminal 2 a message or notification indicative of the next maintenance time in the maintenance management information stored in the user-divided database 1b. For instance, the server 1d transmits to the user terminal 2 the information regarding repair shops available for vehicle inspection among the advertisement requesters, in addition to the inspection time one month before an expiration of valid vehicle license. Thus, the user is enabled to manage maintenance of his or her vehicle by receiving necessary information regarding inspection time and available repair shops. Further, the repair shops are enabled to provide respective services to users and get compensation for the inspection and repair work.

The information processing server 1d links the user-divided database 1a and the advertisement requestor 1b, and transmits the information that are coincides each other between the databases 1a and 1b. That is, the server 1d compares the preference information, e.g., optional parts used in the vehicle and interested parts of a user, stored in the user-divided database 1a is compared with on-sale parts of the advertisement requestor stored in the advertisement requestor-divided database 1b, and transmits to the user terminal 2 parts information which corresponds to the preference of the user.

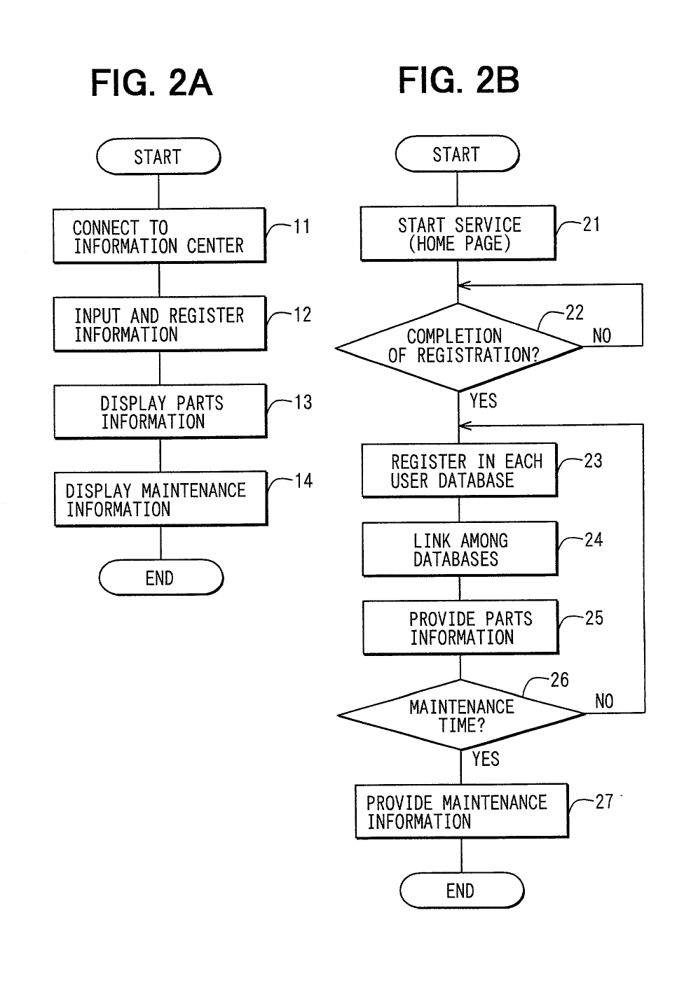

The above information supply processing is described in further detail with reference to FIGS. 2A and 2B. It is assumed in the following description that information providers conclude a contract with advertisement requesters and store private information of each advertisement requester in the advertisement requestor-divided database 1b.

The information provider starts its vehicle-related information supply service such as maintenance management and parts information supply of vehicles by the use of the information center 1. This service may be started by setting up a home page on the INTERNET (step 21).

When a user connects his/her user terminal 2 to the information center 1 (step 11), the information center 1 transmits data input screen to such a user terminal 2 so that the user terminal 2 displays the data input screen as shown in FIG. 3. This data input screen has various input items as the maintenance management information and preference information. These items are, for example, user's name, user's address, user's phone number, user's car, year of purchase, optional parts installed, after-market parts installed after purchase, last oil exchange and the like. The user inputs various required data regarding these items and transmits the input data to the information center 1. Thus, the user completes data input and registration (step 12).

The information center 1 checks at step 22 whether the required data have been input and registered (step 22). If the data registration has been completed (YES), the information center 1 registers or stores in the corresponding address of the user-divided database 1a the private information (maintenance management information and preference information) which the user transmitted (step 23).

In the information center 1, the information processing server 1d links the user-diviede database 1a and the advertisement requestor-divided database 1b (step 24) that have corresponding data. That is, the server 1d checks for data which correspond between stored data of the databases 11a and 1b based on the preference information of the user, because the registered data includes the user's preference. The server 1d thus extracts data which correspond to each other. For instance, if information regarding optional parts or interested parts which the user uses or has interests are registered in the user-divided database 1a, a link is made to a parts-seller part of the advertisement requestor-divided database 1b which stores information of specialized shop or mass retailer having such optional parts or interested parts.

The information center 1 then transmits to the user terminal 2 the extracted parts information as well as the advertisement of the specialized shop and the mass retailer which have such parts (step 25). The user terminal 2 thus displays the parts information and the advertisement transmitted from the information center 1 (step 13), so that the user is enabled to readily find a shop which sells the optional parts and the interested parts and the shop is enabled to attract a new client.

The information processing server 1d further checks whether the registered maintenance management information of the user corresponds to maintenance contents of the advertisement requesters to extract corresponding data. For instance, because the inspection time can be specified from the registered data of year of purchase, a link is made to a part of repair shops and mass retailers registered in the advertisement requestor-divided database 1b to extract such shops which provide a regular vehicle inspection work. That is, the server 1d checks whether it is a vehicle maintenance time for the regular inspection and oil exchange (step 26). For instance, the regular inspection time may be checked whether the present license expires one month later, and the oil exchange time may be checked whether more than six months have passed after the last oil exchange. If it is the maintenance time (YES), the information center 1 transmits to the user terminal 2 the maintenance time information as well as the repair shop or mass retailer information (step 27).

Thus the user terminal 2 receives and displays the transmitted information (step 14) so that the user is enabled to manage his/her vehicle maintenance time and find a repair shop readily. It is preferred that the user inputs data indicating the completion of the vehicle maintenance work thereby to enable the information provider may manage demand of vehicle maintenance work.

In the above embodiment, it is preferred that the maintenance information is provided not only visually but also audibly, because the maintenance information is generally more important than the parts information and the like. This distinction between the visual information and the audible information may be defined by weighing various information with different importance. The maintenance information may be provided to the user repeatedly until the completion of the maintenance work is reported from the user or the repair shop. The maintenance information may be provided through a plurality of means, an electronic mail, a post mail, a telephone call.

It is also preferred that the information regarding repair shops, specialized shops and mass retailers are transmitted with respective location information such as location maps. Particularly when the user terminal 2 is a navigation system, the location of such shops can be indicated on the map of the navigation system.

It is also possible to store parts information of advertisement requesters in the advertisement requestor-divided database 1b for each vehicle model so that the information center 1 can readily link the vehicle information of the user in the database 1a with relevant information in the database 1b by specifying the vehicle model. The advertisement requesters may advertise respective shops and parts in place of asking the information provider to advertise the shops and parts on behalf of the advertisement requesters.

The present invention may be implemented in many other ways without departing from the spirit of the invention.

What is claimed is:

1. A vehicle information supply method executed between an information terminal of a user and an information center through a communication network, the method comprising the steps of:
storing in first storage means maintenance management information of a vehicle owned by a user, the maintenance management information being received from the user;
storing in second storage means maintenance work information regarding maintenance work which are provided by an advertisement requestor;
linking the maintenance management information and the maintenance work information to extract a content of the maintenance work of the advertisement requester which corresponds to a maintenance work required by the vehicle of the user; and
transmitting to the information terminal a message indicative of an arrival of a maintenance time based on the maintenance management information and advertisement requestor information regarding the advertisement requester which provides the extracted maintenance work.

2. The vehicle information supply method as in claim 1, wherein:
the maintenance management information includes a time of purchase of the vehicle of the user; and
the transmitting step transmits a regular vehicle inspection time based on the time of purchase and the information regarding the advertisement requestor which provides a regular vehicle inspection work.

3. The vehicle information supply method as in claim 1, wherein:
the transmitting step further transmits to the user terminal map information regarding a location of the advertisement requestor.

4. A vehicle information supply method executed between an information terminal of a user and an information center through a communication network, the method comprising the steps of:
storing in first storage means parts information of parts which is needed by a user, the parts information being received from the user;
storing in second storage means sales parts information regarding parts which are sold by an advertisement requestor;
linking the parts information of the user and the sales parts information of the advertisement requestor to extract a sales parts of the advertisement requestor which corresponds to a parts needed by the user; and
transmitting to the information terminal through the communication network the extracted sales parts and the advertisement requestor which sells the extracted sales parts.

5. The vehicle information supply method as in claim 4, wherein:
the transmitting step further transmits to the user terminal map information regarding a location of the advertisement requester.

6. The vehicle information supply method as in claim 4, wherein:
the first storing step further stores in the first storage means maintenance management information of a vehicle owned by the user, the maintenance management information being received from the user;
the second storing step further stores in the second storage means maintenance work information regarding maintenance works provided by the advertisement requestor;
the linking step further links the maintenance management information and the maintenance work information to extract a content of the maintenance work of the advertisement requestor which corresponds to a maintenance work required by the vehicle of the user; and
the transmitting step further transmits to the information terminal a message indicative of an arrival of a maintenance time based on the maintenance management information and advertisement requestor information regarding the advertisement requestor which provides the extracted maintenance work.

7. A vehicle information supply system for supplying vehicle information to an information terminal of a user through a communication network, the system comprising:
first storage means for storing maintenance management information of a vehicle owned by a user, the maintenance management information being received from the user;
second storage means for storing maintenance work information regarding maintenance work which are provided by an advertisement requester;
linking means for linking the maintenance management information and the maintenance work information to extract a content of the maintenance work of the advertisement requestor which corresponds to a maintenance work required by the vehicle of the user; and
transmitting means for transmitting to the information terminal a message indicative of an arrival of a maintenance time based on the maintenance management information and advertisement requestor information regarding the advertisement requestor which provides the extracted maintenance work.

8. A vehicle information supply system for supplying vehicle information to an information terminal of a user through a communication network, the system comprising:
first storage means for storing parts information of parts which is needed by a user, the parts information being received from the user;
second storage means for storing sales parts information regarding parts which are sold by an advertisement requestor;
linking means for linking the parts information of the user and the sales parts information of the advertisement requestor to extract a sales parts of the advertisement requestor which corresponds to a parts needed by the user; and
transmitting means for transmitting to the information terminal through the communication network the extracted sales parts and the advertisement requestor which sells the extracted sales parts.

9. A storage medium for storing computer-readable programs which cause an information center to execute a vehicle information supply to an information terminal of a user through a communication network, the programs comprising the steps of:
storing in first storage means maintenance management information of a vehicle owned by a user, the maintenance management information being received from the user;
storing in second storage means maintenance work information regarding maintenance work which are provided by an advertisement requestor;
linking the maintenance management information and the maintenance work information to extract a content of the maintenance work of the advertisement requestor which corresponds to a maintenance work required by the vehicle of the user; and
transmitting to the information terminal a message indicative of an arrival of a maintenance time based on the maintenance management information and advertisement requester information regarding the advertisement requestor which provides the extracted maintenance work.

10. A storage medium for storing computer-readable programs which cause an information center to execute a vehicle information supply to an information terminal of a user through a communication network, the programs comprising the steps of:
storing in first storage means parts information of parts which is needed by a user, the parts information being received from the user;
storing in second storage means sales parts information regarding parts which are sold by an advertisement requester;
linking the parts information of the user and the sales parts information of the advertisement requestor to extract a sales parts of the advertisement requestor which corresponds to a parts needed by the user; and
transmitting to the information terminal through the communication network the extracted sales parts and the advertisement requester which sells the extracted sales parts.
